(19) United States
(12) Patent Application Publication
(10) Pub. No.: US 2018/0051356 A1
(43) Pub. Date: Feb. 22, 2018

(54) METHOD OF PRODUCING GALVANNEALED STEEL SHEET

(71) Applicant: JFE STEEL CORPORATION, Chiyoda-ku, Tokyo (JP)

(72) Inventors: Gentaro TAKEDA, Chiyoda-ku, Tokyo (JP); Masaru MIYAKE, Chiyoda-ku, Tokyo (JP); Yoichi MAKIMIZU, Chiyoda-ku, Tokyo (JP); Yoshitsugu SUZUKI, Chiyoda-ku, Tokyo (JP)

(73) Assignee: JFE STEEL CORPORATION, Chiyoda-ku, Tokyo (JP)

(21) Appl. No.: 15/541,401

(22) PCT Filed: Dec. 18, 2015
(86) PCT No.: PCT/JP2015/006328

§ 371 Date: Jul. 3, 2017

(30) Foreign Application Priority Data
Jan. 8, 2015 (JP) 2015-002543

(51) Int. Cl. C21D 9/56; C21D 9/46; C21D 1/76; C23C 2/02; C23C 2/06; C23C 2/28; C23C 2/40; C21D 6/00; C22C 38/04; C22C 38/02; C22C 38/00; F27D 7/06; F27D 7/02

(52) U.S. Cl. CPC C21D 9/561; F27D 2007/063; C21D 1/76; C23C 2/02; C23C 2/06; C23C 2/28; C23C 2/40; C21D 6/005; C21D 6/008; C22C 38/04; C22C 38/02; C22C 38/002; F27D 7/06; F27D 7/02; C21D 9/46

(57) ABSTRACT

A method of producing a galvannealed steel sheet whereby favorable coating appearance can be obtained with high coating adhesion even in the case of galvannealing a steel strip whose Si content is 0.2 mass % or more, and a decrease in tensile strength can be prevented by lowering the alloying temperature. Mixed gas of humidified gas and dry gas, and dry gas are supplied to a soaking zone in an annealing furnace. The mixed gas is timely supplied from a position of lower half of the soaking zone. The dry gas is timely supplied from near an upper hearth roll in the soaking zone, and furnace gas is timely discharged from a gas discharge port located higher than the upper hearth roll, to control a dew point in at least an uppermost part of the soaking zone to −20° C. or more and 0° C. or less.

### TECHNICAL FIELD

The disclosure relates to a method of producing a galvannealed steel sheet using a continuous hot-dip galvanizing device that includes: an annealing furnace in which a heating zone, a soaking zone, and a cooling zone are arranged in this order; a hot-dip galvanizing line adjacent to the cooling zone; and an alloying line adjacent to the hot-dip galvanizing line.

### BACKGROUND

In recent years, the demand for high tensile strength steel sheets (high tensile strength steel materials) which contribute to more lightweight structures and the like is increasing in the fields of automobiles, household appliances, building products, etc. As high tensile strength steel sheets, for example, it is known that a steel sheet with favorable hole expandability can be produced by containing Si in steel, and a steel sheet with favorable ductility where retained austenite (γ) forms easily can be produced by containing Si or Al in steel.

However, in the case of producing a galvannealed steel sheet using, as a base material, a high tensile strength steel sheet containing a large amount of Si (particularly, 0.2 mass % or more), the following problem arises. The galvannealed steel sheet is produced by, after heat-annealing the steel sheet as the base material at a temperature of about 600° C. to 900° C. in a reducing atmosphere or a non-oxidizing atmosphere, hot-dip galvanizing the steel sheet and further heat-alloying the galvanized coating.

Here, Si in the steel is an oxidizable element, and is selectively oxidized in a typically used reducing atmosphere or non-oxidizing atmosphere and concentrated in the surface of the steel sheet to form an oxide. This oxide decreases wettability with molten zinc in the galvanizing process, and causes non-coating. With an increase of the Si concentration in the steel, wettability decreases rapidly and non-coating occurs frequently. Even in the case where non-coating does not occur, there is still a problem of poor coating adhesion. Besides, if Si in the steel is selectively oxidized and concentrated in the surface of the steel sheet, a significant alloying delay arises in the alloying process after the hot-dip galvanizing, leading to considerably lower productivity.

In view of such problems, for example, JP 2010-202959 A (PTL 1) describes the following method. With use of a direct fired furnace (DFF), the surface of a steel sheet is oxidized and then the steel sheet is annealed in a reducing atmosphere to internally oxidize Si and prevent Si from being concentrated in the surface of the steel sheet, thus improving the wettability and adhesion of the hot-dip galvanized coating. PTL 1 describes that the reducing annealing after heating may be performed by a conventional method (dew point: −30° C. to −40° C.).

WO2007/043273 A1 (PTL 2) describes the following technique. In a continuous annealing and hot-dip coating method that uses an annealing furnace having an upstream heating zone, a downstream heating zone, a soaking zone, and a cooling zone arranged in this order and a hot-dip molten bath, annealing is performed under the following conditions to internally oxidize Si and prevent Si from being concentrated in the surface of the steel sheet: heating or soaking the steel sheet at a steel sheet temperature in the range of at least 300° C. by indirect heating; setting the atmosphere inside the furnace in each zone to an atmosphere of 1 vol % to 10 vol % hydrogen with the balance being nitrogen and incidental impurities; setting the steel sheet end-point temperature during heating in the upstream heating zone to 550° C. or more and 750° C. or less and the dew point in the upstream heating zone to less than −25° C.; setting the dew point in the subsequent downstream heating zone and soaking zone to −30° C. or more and 0° C. or less; and setting the dew point in the cooling zone to less than −25° C. PTL 2 also describes humidifying mixed gas of nitrogen and hydrogen and introducing it into the downstream heating zone and/or the soaking zone.

JP 2009-209397 A (PTL 3) describes the following technique. While measuring the dew point of furnace gas, the supply and discharge positions of furnace gas are changed depending on the measurement to control the dew point of the gas in the reducing furnace to be in the range of more than −30° C. and 0° C. or less, thus preventing Si from being concentrated in the surface of the steel sheet. PTL 3 describes that the heating furnace may be any of a direct fired furnace (DFF), a non-oxidizing furnace (NOF), and a radiant tube, but a radiant tube is preferable as it produces significantly advantageous effects.

JP 2013-245362 A (PTL 4) describes a technique of decreasing the dew point in the annealing furnace to −50° C. or less by a refiner to prevent Si or Mn from being concentrated in the surface. PTL 4 describes that troubles such as pick-up defects do not occur because the annealing furnace can be set to a stable low-dew-point atmosphere in a short time.

### CITATION LIST

### Patent Literatures

PTL 1: JP 2010-202959 A

PTL 2: WO2007/043273 A1

PTL 3: JP 2009-209397 A

PTL 4: JP 2013-245362 A

### SUMMARY

### Technical Problem

However, with the method described in PTL 1, although the coating adhesion after the reduction is favorable, the amount of Si internally oxidized tends to be insufficient, and Si in the steel causes the alloying temperature to be higher than typical temperature by 30° C. to 50° C., as a result of which the tensile strength of the steel sheet decreases. If the oxidation amount is increased to ensure a sufficient amount of Si internally oxidized, oxide scale attaches to rolls in the annealing furnace, inducing pressing flaws, i.e. pick-up defects, in the steel sheet. The means for simply increasing the oxidation amount is therefore not applicable.

With the method described in PTL 2, since the heating or soaking in the upstream heating zone, downstream heating zone, and soaking zone is performed by indirect heating, the oxidation of the surface of the steel sheet like that by direct firing in PTL 1 is unlikely to occur, and the internal oxidation of Si is insufficient as compared with PTL 1. The problem of an increase in alloying temperature is therefore more serious. Moreover, not only the amount of moisture brought into the furnace varies depending on the external air temperature change or the steel sheet type, but also the dew point of the mixed gas tends to vary depending on the external air temperature change, making it difficult to stably control the dew point in the optimal dew point range. Due to such large dew point variation, surface defects such as non-coating occur even within the aforementioned dew point ranges and temperature ranges. The production of stable products is therefore difficult.

With the method described in PTL 3, although the use of a DFF in the heating furnace may enable the oxidation of the surface of the steel sheet, stably controlling the dew point in a high dew point range of −20° C. to 0° C. in the aforementioned control range is difficult because humidified gas is not actively supplied to the annealing furnace. Besides, in the case where the dew point increases, the dew point in the upper part of the furnace tends to be high. For example, while a dew point meter in the lower part of the furnace indicates 0° C., the atmosphere in the upper part of the furnace has a high dew point of +10° C. or more. Operating the furnace in such a state for a long time has been found to cause pick-up defects.

With the method described in PTL 4, the concentration of Si, Mn, etc. in the surface is suppressed to increase the wettability of the hot-dip galvanized coating. However, given that the alloying reaction of iron and zinc is delayed by solute elements, the alloying temperature needs to be increased excessively to obtain a predetermined alloying degree. This makes it difficult to achieve a balance with the mechanical properties of the material.

It could therefore be helpful to provide a method of producing a galvannealed steel sheet whereby favorable coating appearance can be obtained with high coating adhesion even in the case of galvannealing a steel strip whose Si content is 0.2 mass % or more, and a decrease in tensile strength can be prevented by lowering the alloying temperature.

### Solution to Problem

The disclosed technique suppresses the concentration of Si in the surface and lowers the alloying temperature by sufficiently oxidizing the surface of the steel sheet by use of a direct fired furnace (DFF) in the heating zone and then sufficiently internally oxidizing Si with the whole soaking zone being set to a dew point higher than that in conventional methods.

We provide the following:

(1) A method of producing a galvannealed steel sheet using a continuous hot-dip galvanizing device that includes: an annealing furnace in which a heating zone including a direct fired furnace, a soaking zone, and a cooling zone are arranged in the stated order; a hot-dip galvanizing line adjacent to the cooling zone; and an alloying line adjacent to the hot-dip galvanizing line, the method comprising: annealing a steel strip by conveying the steel strip through the heating zone, the soaking zone, and the cooling zone in the stated order in the annealing furnace; applying a hot-dip galvanized coating onto the steel strip discharged from the cooling zone, using the hot-dip galvanizing line; and heat-alloying the galvanized coating applied on the steel strip, using the alloying line, wherein reducing gas or non-oxidizing gas is supplied into the soaking zone, the reducing gas or the non-oxidizing gas including: mixed gas obtained by mixing gas humidified by a humidifying device and gas not humidified by the humidifying device at a predetermined mixture ratio; and dry gas not humidified by the humidifying device, the mixed gas is timely supplied into the soaking zone from at least one mixed gas supply port located in a region of lower ½ of the soaking zone in a height direction, and the dry gas is timely supplied into the soaking zone from at least one dry gas supply port located at or in a range of 2 m lower than a center of an upper hearth roll in the soaking zone in the height direction, and furnace gas is timely discharged from the soaking zone through at least one gas discharge port located higher than the upper hearth roll, to control a dew point in at least an uppermost part of the soaking zone to −20° C. or more and 0° C. or less.

(2) The method of producing a galvannealed steel sheet according to (1), wherein the furnace gas discharged through the at least one gas discharge port is introduced into a refiner having a deoxidizing device and a dehumidifying device to remove oxygen and moisture in the furnace gas and decrease a dew point of the furnace gas to obtain second dry gas, and the second dry gas is used as the dry gas timely supplied into the soaking zone from the at least one dry gas supply port.

(3) The method of producing a galvannealed steel sheet according to (1) or (2), wherein the supply of the mixed gas is controlled so that both a dew point in a region of upper ½ of the soaking zone in the height direction and a dew point in a lowermost part of the soaking zone are −20° C. or more and 0° C. or less.

(4) The method of producing a galvannealed steel sheet according to any one of (1) to (3), wherein the at least one gas discharge port includes a plurality of gas discharge ports located at a same height position, and/or the at least one dry gas supply port includes a plurality of dry gas supply ports located at a same height position.

(5) The method of producing a galvannealed steel sheet according to any one of (1) to (4), wherein the at least one mixed gas supply port includes a plurality of mixed gas supply ports located at each of two or more different height positions.

(6) The method of producing a galvannealed steel sheet according to any one of (1) to (5), wherein an oxidizing burner and a reducing burner situated downstream of the oxidizing burner in a steel sheet traveling direction are provided in the direct fired furnace, and an air ratio of the oxidizing burner is adjusted to 0.95 or more and 1.5 or less, and an air ratio of the reducing burner is adjusted to 0.5 or more and less than 0.95.

### Advantageous Effect

It is thus possible to obtain favorable coating appearance with high coating adhesion even in the case of galvannealing a steel strip whose Si content is 0.2 mass % or more, and prevent a decrease in tensile strength by lowering the alloying temperature.

### BRIEF DESCRIPTION OF THE DRAWINGS

In the accompanying drawings:

FIG. 1 is a sectional diagram illustrating the structure of a continuous hot-dip galvanizing device 100 used in a method of producing a galvannealed steel sheet according to one of the disclosed embodiments; and

FIG. 2 is a schematic diagram illustrating the supply of mixed gas and dry gas to a soaking zone 12 and the discharge of furnace gas from the soaking zone 12 in FIG. 1.

### DETAILED DESCRIPTION

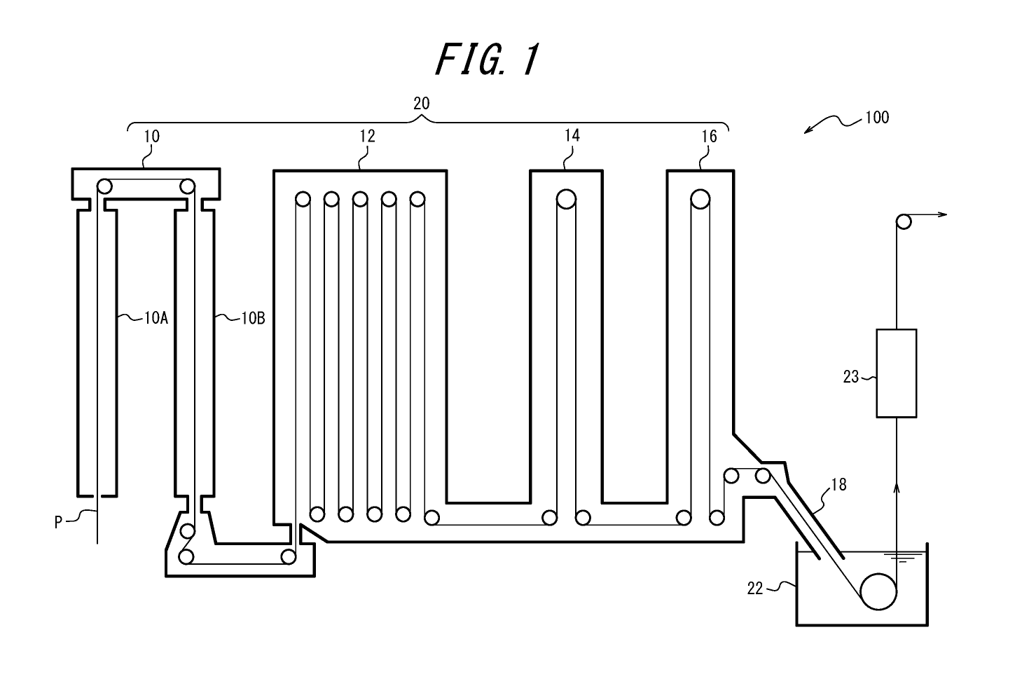

The structure of a continuous hot-dip galvanizing device 100 used in a method of producing a galvannealed steel sheet according to one of the disclosed embodiments is described first, with reference to FIG. 1. The continuous hot-dip galvanizing device 100 includes: an annealing furnace 20 in which a heating zone 10, a soaking zone 12, and cooling zones 14 and 16 are arranged in this order; a hot-dip galvanizing bath 22 as a hot-dip galvanizing line adjacent to the cooling zone 16; and an alloying line 23 adjacent to the hot-dip galvanizing bath 22. In this embodiment, the heating zone 10 includes a first heating zone 10A (upstream heating zone) and a second heating zone 10B (downstream heating zone). The cooling zone includes a first cooling zone 14 (rapid cooling zone) and a second cooling zone 16 (slow cooling zone). A snout 18 connected to the second cooling zone 16 has its tip immersed in the hot-dip galvanizing bath 22, thus connecting the annealing furnace 20 and the hot-dip galvanizing bath 22. One of the disclosed embodiments is a method of producing a galvannealed steel sheet using the continuous hot-dip galvanizing device 100.

A steel strip P is introduced from a steel strip introduction port in the lower part of the first heating zone 10A into the first heating zone 10A. One or more hearth rolls are arranged in the upper and lower parts in each of the zones 10, 12, 14, and 16. In the case where the steel strip P is folded back by 180 degrees at one or more hearth rolls, the steel strip P is conveyed vertically a plurality of times inside the corresponding predetermined zone, forming a plurality of passes. While FIG. 1 illustrates an example of having 10 passes in the soaking zone 12, 2 passes in the first cooling zone 14, and 2 passes in the second cooling zone 16, the numbers of passes are not limited to such, and may be set as appropriate depending on the processing condition. At some hearth rolls, the steel strip P is not folded back but changed in direction at the right angle to move to the next zone. The steel strip P is thus annealed in the annealing furnace 20 by being conveyed through the heating zone 10, the soaking zone 12, and the cooling zones 14 and 16 in this order.

Adjacent zones in the annealing furnace 20 communicate through a communication portion connecting the upper parts or lower parts of the respective zones. In this embodiment, the first heating zone 10A and the second heating zone 10B communicate through a throat (restriction portion) connecting the upper parts of the respective zones. The second heating zone 10B and the soaking zone 12 communicate through a throat connecting the lower parts of the respective zones. The soaking zone 12 and the first cooling zone 14 communicate through a throat connecting the lower parts of the respective zones. The first cooling zone 14 and the second cooling zone 16 communicate through a throat connecting the lower parts of the respective zones. The height of each throat may be set as appropriate. Given that the diameter of each hearth roll is about 1 m, the height of each throat is preferably set to 1.5 m or more. Meanwhile, the height of each communication portion is preferably as low as possible, to enhance the independence of the atmosphere in each zone. The gas in the annealing furnace 20 flows from downstream to upstream in the furnace, and is discharged from the steel strip introduction port in the lower part of the first heating zone 10A.

(Heating Zone)

In this embodiment, the second heating zone 10B is a direct fired furnace (DFF). The DFF may be, for example, a well-known DFF as described in PTL 1. A plurality of burners are distributed in the inner wall of the direct fired furnace in the second heating zone 10B so as to face the steel strip P, although not illustrated in FIG. 1. Preferably, the plurality of burners are divided into a plurality of groups, and the combustion rate and the air ratio in each group are independently controllable. Combustion exhaust gas in the second heating zone 10B is supplied to the first heating zone 10A, and the steel strip P is preheated by the heat of the gas.

The combustion rate is a value obtained by dividing the amount of fuel gas actually introduced into a burner by the amount of fuel gas of the burner under its maximum combustion load. The combustion rate at the time of combustion by the burner under its maximum combustion load is 100%. When the combustion load is low, the burner cannot maintain a stable combustion state. Accordingly, the combustion rate is preferably adjusted to 30% or more.

The air ratio is a value obtained by dividing the amount of air actually introduced into a burner by the amount of air necessary for complete combustion of fuel gas. In this embodiment, the heating burners in the second heating zone 10B are divided into four groups (#1 to #4), and the three groups (#1 to #3) upstream in the steel sheet traveling direction are made up of oxidizing burners, and the last group (#4) is made up of reducing burners. The air ratio of the oxidizing burners and the air ratio of the reducing burners are independently controllable. The air ratio of the oxidizing burners is preferably adjusted to 0.95 or more and 1.5 or less. The air ratio of the reducing burners is preferably adjusted to 0.5 or more and less than 0.95. The temperature in the second heating zone 10B is preferably adjusted to 800° C. to 1200° C.

(Soaking Zone)

In this embodiment, the soaking zone 12 is capable of indirectly heating the steel strip P using a radiant tube (RT) (not illustrated) as heating means. The average temperature Tr (° C.) in the soaking zone 12 is measured by a thermocouple inserted into the soaking zone, and is preferably adjusted to 700° C. to 900° C.

Reducing gas or non-oxidizing gas is supplied to the soaking zone 12. As the reducing gas, H₂—N₂ mixed gas is typically used. An example is gas (dew point: about −60° C.) having a composition containing 1 vol % to 20 vol % H₂ with the balance being N₂ and incidental impurities. An example of the non-oxidizing gas is gas (dew point: about −60° C.) having a composition containing N₂ and incidental impurities.

In this embodiment, the reducing gas or non-oxidizing gas supplied to the soaking zone 12 has two forms, namely, mixed gas and dry gas. Here, “dry gas” is reducing gas or non-oxidizing gas having a dew point of about −60° C. to −50° C. and not humidified by a humidifying device, and “mixed gas” is gas obtained by mixing gas humidified by the humidifying device and gas not humidified by the humidifying device at a predetermined mixture ratio so that the dew point is −20° C. to 10° C.

In the reducing annealing step in the soaking zone 12, an iron oxide formed in the surface of the steel strip in the oxidation step in the heating zone 10 is reduced, and an alloying element of Si or Mn forms an internal oxide inside the steel strip by oxygen supplied from the iron oxide. As a result, a reduced iron layer reduced from the iron oxide forms in the outermost surface of the steel strip, while Si or Mn remains inside the steel strip as an internal oxide. In this way, the oxidation of Si or Mn in the surface of the steel strip is suppressed and a decrease in wettability of the steel strip and hot-dip coating is prevented, as a result of which favorable coating adhesion is attained without non-coating.

Although favorable coating adhesion is attained in this way, a high alloying temperature in Si-containing steel may cause the decomposition of the retained austenite phase into the pearlite phase or the temper softening of the martensite phase, making it impossible to achieve desired mechanical properties. We accordingly studied a technique for lowering the alloying temperature, and discovered that, by further encouraging the internal oxidation of Si, the amount of solute Si in the surface layer of the steel strip can be reduced to facilitate the alloying reaction. An effective way to achieve this is to control the dew point of the atmosphere in the soaking zone 12 to −20° C. or more.

If the dew point in the soaking zone 12 is controlled to −20° C. or more, even after an internal oxide of Si forms by oxygen supplied from the iron oxide, the internal oxidation of Si continues by oxygen supplied from H₂O in the atmosphere, so that more internal oxidation of Si takes place. As a result, the amount of solute Si decreases in the region inside the surface layer of the steel strip where the internal oxidation has occurred. When the amount of solute Si decreases, the surface layer of the steel strip behaves like low Si steel, and the subsequent alloying reaction is facilitated. The alloying reaction thus progresses at low temperature. As a result of lowering the alloying temperature, the retained austenite phase can be maintained at a high proportion, which contributes to improved ductility. Moreover, the temper softening of the martensite phase does not progress, and so desired strength is obtained. Since the steel substrate of the steel strip starts oxidizing when the dew point is +10° C. or more in the soaking zone 12, the upper limit of the dew point is preferably 0° C. in terms of the uniformity of the dew point distribution in the soaking zone 12 and the minimization of the dew point variation range.

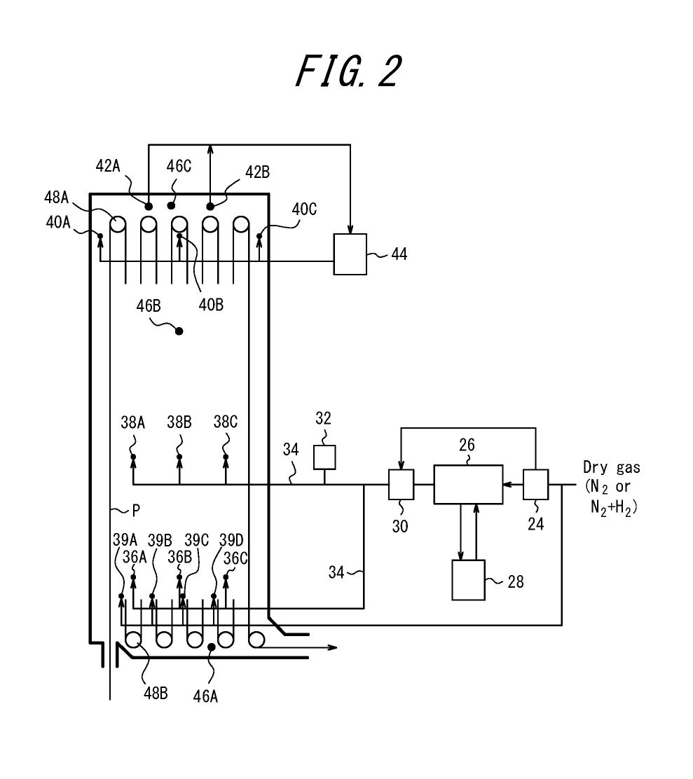

Thus, the disclosure relates to a method of controlling the dew point of the atmosphere in the soaking zone 12 constantly to −20° C. to 0° C. A dew point meter is placed in at least one location (dew point measurement position 46A) near a lower hearth roll 48B (a lowermost part of the soaking zone), at least one location (dew point measurement position 46C) higher than an upper hearth roll 48A (an uppermost part of the soaking zone), and at least one location (dew point measurement position 46B) lower than the upper hearth roll 48A and higher than ½ of the soaking zone in the height direction (an upper part of the soaking zone). FIG. 2 is a schematic diagram illustrating the supply of mixed gas and dry gas to the soaking zone 12 and the discharge of furnace gas from the soaking zone 12.

The dry gas is constantly supplied into the soaking zone 12 from at least one dry gas supply port (four dry gas supply ports 39A to 39D in this embodiment) located in the region of lower ½ of the soaking zone 12 in the height direction. This is a general condition.

The mixed gas is timely supplied into the soaking zone 12 from at least one mixed gas supply port located in the region of lower ½ of the soaking zone 12 in the height direction. In this embodiment, the mixed gas is supplied through two systems, namely, mixed gas supply ports 36A, 36B, and 36C and mixed gas supply ports 38A, 38B, and 38C. In FIG. 2, a gas distribution device 24 feeds part of the reducing gas or non-oxidizing gas (dry gas) to a humidifying device 26 and the remaining part to a gas mixing device 30. The gas mixing device 30 mixes the gas humidified by the humidifying device 26 and the dry gas directly fed from the gas distribution device 24 at a predetermined ratio, to prepare mixed gas with a predetermined dew point. The prepared mixed gas passes through a mixed gas pipe 34, and is supplied into the soaking zone 12 from the mixed gas supply ports 36 and 38. Reference sign 32 is a mixed gas dew point meter.

The humidifying device 26 includes a humidifying module having a fluorine or polyimide hollow fiber membrane, flat membrane, or the like. Dry gas flows inside the membrane, whereas pure water adjusted to a predetermined temperature in a circulating constant-temperature water bath 28 circulates outside the membrane. The fluorine or polyimide hollow fiber membrane or flat membrane is a type of ion exchange membrane with affinity for water molecules. When moisture content differs between the inside and outside of the hollow fiber membrane, a force for equalizing the moisture content difference emerges and, with this force as a driving force, moisture transmits through the membrane and moves toward the part with lower moisture content. The temperature of dry gas varies with seasonal or daily air temperature change. In this humidifying device, however, heat exchange is possible by ensuring a sufficient contact area between gas and water through the vapor permeable membrane. Accordingly, regardless of whether the dry gas temperature is higher or lower than the circulating water temperature, the dry gas is humidified to the same dew point as the set water temperature, thus achieving highly accurate dew point control. The dew point of the humidified gas can be controlled to any value in the range of 5° C. to 50° C. When the dew point of the humidified gas is higher than the pipe temperature, there is a possibility that dew condensation occurs in the pipe and dew condensation water enters directly into the furnace. The humidified gas pipe is therefore heated/heat-retained to be not less than the dew point of the humidified gas and not less than the external air temperature.

By adjusting the gas mixture ratio in the gas mixing device 30, the mixed gas of any dew point can be supplied into the soaking zone 12. When the dew point in the soaking zone 12 is below the desired range, the mixed gas with a higher dew point is supplied. When the dew point in the soaking zone 12 exceeds the desired range, the mixed gas with a lower dew point is supplied. Thus, the dew point in the region of upper ½ of the soaking zone in the height direction (dew point measurement position 46B) and the dew point in the lowermost part of the soaking zone (dew point measurement position 46A) can both be controlled to −20° C. or more and 0° C. or less.

The dew point and flow rate of the mixed gas introduced can be set by determining the introduction amount depending on the size of the steel sheet to be produced and the line speed beforehand. The response time from when the introduction of the mixed gas starts to when the dew point actually starts increasing is also determined beforehand. For example, if the response time is 5 minutes, the mixed gas is introduced 5 minutes before the steel sheet enters the soaking zone. The time from when the introduction of the mixed gas stops to when the dew point returns to a normal range is determined beforehand, too, to successively reduce the mixed gas a predetermined time before the steel sheet exits the soaking zone. Thus, the mixed gas is timely introduced according to the passage of the steel sheet. While the steel sheet is passing through the soaking zone, the flow rate of the mixed gas may be basically constant, but be changed depending on a change in line speed or other operation conditions or a change in dew point of the furnace.

It is important in the disclosure to control the supply of the dry gas in the upper part of the soaking zone 12 and the discharge of the furnace gas from the uppermost part of the soaking zone 12 to maintain the dew point in the uppermost part of the soaking zone 12 (dew point measurement position 46C) at −20° C. to 0° C. Given that water vapor has a lower specific gravity than nitrogen gas, the dew point tends to be high in the upper part of the soaking zone 12. Since the steel substrate of the steel strip starts oxidizing when the dew point is +10° C. or more in the soaking zone 12, the upper limit of the dew point is preferably 0° C. in terms of the uniformity of the dew point distribution in the soaking zone 12 and the minimization of the dew point variation range. Accordingly, the dry gas is timely supplied into the soaking zone 12 from at least one dry gas supply port (three dry gas supply ports 40A, 40B, and 40C in this embodiment) located at or in the range of 2 m lower than the center of the upper hearth roll 48A in the height direction. In addition, the furnace gas is timely discharged from the soaking zone 12 through at least one gas discharge port (two gas discharge ports 42A and 42B in this embodiment) located higher than the upper hearth roll 48A. The dew point in the uppermost part of the soaking zone 12 is controlled to −20° C. or more and 0° C. or less in this way.

For example, when the dew point in the uppermost part of the soaking zone 12 (dew point measurement position 46C) is −5° C. or more, the dry gas is supplied and the furnace gas is discharged. When the dew point is −15° C. or less, the supply of the dry gas and the discharge of the furnace gas are stopped. By discharging the furnace gas having a high dew point and supplying the dry gas having a low dew point, the dew point in the uppermost part of the soaking zone 12 can be lowered effectively.

A refiner 44 having a deoxidizing device and a dehumidifying device is desirably used, as in this embodiment. In such a case, the furnace gas discharged through the gas discharge ports 42A and 42B is introduced into the refiner to remove oxygen and moisture in the furnace gas and decrease its dew point, thus obtaining second dry gas. The second dry gas is timely supplied into the soaking zone 12 from the dry gas supply ports 40A, 40B, and 40C. In this way, high-dew-point gas in the uppermost part is promptly discharged without varying the furnace pressure and without decreasing the dew point in most parts of the soaking zone 12, so that troubles such as pick-up defects can be avoided.

Preferably, a plurality of gas discharge ports are located at the same height position and/or a plurality of dry gas supply ports are located at the same height position, as in this embodiment. More preferably, the gas discharge ports and/or the dry gas supply ports are evenly distributed in the steel strip traveling direction (horizontal direction).

Preferably, a plurality of mixed gas supply ports are located at each of two or more different height positions, as in this embodiment. More preferably, the mixed gas supply ports are evenly distributed in the steel strip traveling direction (horizontal direction).

The gas flow rate Qrw while the mixed gas is being supplied to the soaking zone 12 is measured by a gas flowmeter (not illustrated) provided in the pipe 34. The gas flow rate Qrw is not particularly limited, but is about 100 to 500 (Nm³/hr). Thus, the furnace pressure in the soaking zone 12 is maintained appropriately (higher than the direct fired zone), without becoming excessively high.

The moisture content Wr of the mixed gas supplied to the soaking zone 12 is measured by a dew point meter. The moisture content Wr is not particularly limited, but is about 2820 to 12120 (ppm). With this range, the dew point in the soaking zone 12 is easily maintained at −20° C. to 0° C. The moisture content Wr can be calculated from the dew point of the mixed gas according to the following Formula (1):

Wr=6028.614×10^{7.5T/(T+237.3)} [Math. 1]

where T is the dew point (° C.).

The gas flow rate Qrd of the dry gas constantly supplied to the soaking zone 12 from the dry gas supply port (the dry gas supply ports 39A to 39D in this embodiment) located in the region of lower ½ of the soaking zone 12 in the height direction is measured by a gas flowmeter (not illustrated) provided in the pipe. The gas flow rate Qrd is not particularly limited, but is about 0 to 600 (Nm³/hr). Thus, the furnace pressure in the soaking zone 12 is maintained appropriately (higher than the direct fired zone), without becoming excessively high.

(Cooling Zone)

In this embodiment, the cooling zones 14 and 16 cool the steel strip P. The steel strip P is cooled to about 480° C. to 530° C. in the first cooling zone 14, and cooled to about 470° C. to 500° C. in the second cooling zone 16.

The cooling zones 14 and 16 are also supplied with the aforementioned reducing gas or non-oxidizing gas. Here, only the dry gas is supplied. The supply of the dry gas to the cooling zones 14 and 16 is not particularly limited, but the dry gas is preferably supplied from introduction ports in two or more locations in the height direction and two or more locations in the longitudinal direction so that the dry gas is evenly introduced into the cooling zones. The total gas flow rate Qcd of the dry gas supplied to the cooling zones 14 and 16 is measured by a gas flowmeter (not illustrated) provided in the pipe. The total gas flow rate Qcd is not particularly limited, but is about 200 to 1000 (Nm³/hr). Thus, the furnace pressure in the soaking zone 12 is maintained appropriately (higher than the direct fired zone), without becoming excessively high.

(Hot-Dip Galvanizing Bath)

The hot-dip galvanizing bath 22 can be used to apply a hot-dip galvanized coating onto the steel strip P discharged from the second cooling zone 16. The hot-dip galvanizing may be performed according to a usual method.

(Alloying Line)

The alloying line 23 can be used to heat-alloy the galvanized coating applied on the steel strip P. The alloying treatment may be performed according to a usual method. In this embodiment, the alloying temperature is kept from being high, thus preventing a decrease in tensile strength of the produced galvannealed steel sheet.

The steel strip P subjected to annealing and hot-dip galvanizing is not particularly limited, but the advantageous effects can be effectively achieved in the case where the steel strip has a chemical composition in which Si content is 0.2 mass % or more.

### Examples

### Experimental Conditions

The continuous hot-dip galvanizing device illustrated in FIGS. 1 and 2 was used to anneal each steel strip whose chemical composition is shown in Table 1 under each annealing condition shown in Table 2, and then hot-dip galvanize and alloy the steel strip.

A DFF was used as the second heating zone. The heating burners were divided into four groups (#1 to #4) where the three groups (#1 to #3) upstream in the steel sheet traveling direction were made up of oxidizing burners and the last group (#4) was made up of reducing burners, and the air ratios of the oxidizing burners and reducing burners were set to the values shown in Table 2. The length of each group in the steel sheet traveling direction was 4 m.

A RT furnace having the volume Vr of 700 m³ was used as the soaking zone. The average temperature Tr in the soaking zone was set to the value shown in Table 2. As dry gas, gas (dew point: −50° C.) having a composition containing 15 vol % H₂ with the balance being N₂ and incidental impurities was used. Part of the dry gas was humidified by a humidifying device having a hollow fiber membrane-type humidifying portion, to prepare mixed gas. The hollow fiber membrane-type humidifying portion was made up of 10 membrane modules, in each of which dry gas of 500 L/min at the maximum and circulating water of 10 L/min at the maximum were flown. A common circulating constant-temperature water bath capable of supplying pure water of 100 L/min in total was used. Dry gas supply ports and mixed gas supply ports were arranged at the positions illustrated in FIG. 2. The dry gas was constantly supplied at the flow rate Qrd shown in Table 2, from the dry gas supply ports (39A to 39D) in the lower part of the soaking zone illustrated in FIG. 2. In Nos. 2, 3, 5, 6, 8, and 9 in Table 2, the mixed gas was timely supplied. With the humidifying device used in this example, it took 5 minutes for the dew point to increase to a predetermined range, and it took 1 minute for the dew point to reach a normal range in the case of stopping the introduction of the mixed gas and introducing only the dry gas. Hence, the introduction of the mixed gas was started 5 minutes before the steel sheet entered the soaking zone, and the mixed gas introduction amount was reduced 1 minute before the steel sheet exited the soaking zone. In Nos. 1, 4, and 7 in Table 2, the mixed gas was not supplied.

In Nos. 3, 6, and 9 (Examples) in Table 2, a circulatory system in which the furnace gas discharged through the gas discharge ports was introduced into a refiner to be converted into dry gas from which oxygen and moisture was removed and the dry gas was supplied again into the soaking zone from the dry gas supply ports was used. This circulation was performed only in the case where the dew point in the uppermost part of the soaking zone (dew point measurement position 46C) was −5° C. or more. In Nos. 1, 2, 4, 5, 7, and 8 (Comparative Examples) in Table 2, such gas control in the furnace upper part was not performed. Other conditions are shown in Table 2.

The dry gas (dew point: −50° C.) was supplied to the first and second cooling zones from their lowermost parts with the flow rate shown in Table 2.

The temperature of the molten bath was set to 460° C., the Al concentration in the molten bath was set to 0.130%, and the coating weight was adjusted to 45 g/m² per surface by gas wiping. The line speed was set to 80 mpm to 100 mpm. After the hot-dip galvanizing, alloying treatment was performed in an induction heating-type alloying furnace so that the coating alloying degree (Fe content) was 10% to 13%. The alloying temperature in the treatment is shown in Table 2.

(Evaluation Method)

The evaluation of the coating appearance was conducted through inspection by an optical surface defect meter (detection of non-coating defects or overoxidation defects of φ0.5 or more) and visual determination of alloying unevenness. Samples accepted on all criteria were rated “good”, samples having a low degree of alloying unevenness were rated “fair”, and samples rejected on at least one of the criteria were rated “poor”. The length of alloying unevenness per 1000 m coil was also measured. The results are shown in Table 2.

In addition, the tensile strength of a galvannealed steel sheet produced under each condition was measured. Steel with steel sample ID A was rated as “pass” when the tensile strength was 590 MPa or more, steel with steel sample ID B was rated as “pass” when the tensile strength was 780 MPa or more, and steel with steel sample ID C was rated as “pass” when the tensile strength was 980 MPa or more. The results are shown in Table 2.

Further, for each of Nos. 1 to 10, the dew point in the soaking zone when the gas flow rate and the dew point were stable was measured at the positions illustrated in FIG. 2. The results are shown in Table 2.

(Evaluation Results)

In Nos. 3, 6, and 9 of Examples in which the mixed gas was supplied and the furnace gas with a high dew point was timely discharged and the dry gas with a low dew point was timely supplied in the upper part of the soaking zone, the dew point was stably controlled to −20° C. to 0° C. in the entire soaking zone. As a result, the coating appearance was favorable, and the tensile strength was high. In Nos. 1, 4, and 7 in which the mixed gas was not supplied, on the other hand, the coating appearance was poor, and alloying became uneven. Besides, the alloying temperature increased and the tensile strength decreased in all steel sample IDs. In Nos. 2, 5, and 8 in which the mixed gas was supplied but the gas control in the furnace upper part was not performed, the dew point exceeded 0° C. in the uppermost part of the soaking zone, as a result of which pickup defects occurred and the coating appearance was unsatisfactory.

TABLE 1
(mass %)

| Steel ID | C | Si | Mn | P | S |
|---|---|---|---|---|---|
| A | 0.08 | 0.25 | 1.5 | 0.03 | 0.001 |
| B | 0.12 | 1.4 | 1.9 | 0.01 | 0.001 |
| C | 0.11 | 1.5 | 2.7 | 0.01 | 0.001 |

TABLE 2

| | | | | | Soaking zone (RTF) | | | | | |
|---|---|---|---|---|---|---|---|---|---|---|
| | | | | | | | | | Dry gas | |
| | | Heating zone (DFF) | | | | | | Average | flow rate in | Mixed gas |
| | | Air ratio of | Air ratio of | Delivery | Dew point of | Dew point of | Dew point of | temperature | furnace lower part | flow rate |
| | Steel | oxidizing | reducing | temperature | uppermost part | upper part | lowermost part | Tr | Qrd | Qrw |
| No. | ID | burner | burner | (° C.) | (° C.) | (° C.) | (° C.) | (° C.) | (Nm³/hr) | (Nm³/hr) |
| 1 | A | 0.95 | 0.85 | 680 | −25.2 | −30.5 | −42.7 | 800 | 653 | 0 |
| 2 | A | 0.95 | 0.85 | 678 | 1.2 | −6.8 | −12.2 | 802 | 404 | 250 |
| 3 | A | 0.95 | 0.85 | 680 | −15.2 | −10.3 | −12.2 | 805 | 404 | 250 |
| 4 | B | 1.10 | 0.85 | 747 | −20.5 | −27.2 | −36.3 | 835 | 752 | 0 |
| 5 | B | 1.10 | 0.85 | 750 | 2.5 | −11.8 | −14.9 | 832 | 510 | 250 |
| 6 | B | 1.10 | 0.85 | 752 | −17.3 | −12.3 | −16.2 | 830 | 510 | 250 |
| 7 | C | 1.15 | 0.85 | 721 | −26.1 | −31.7 | −39.3 | 849 | 745 | 0 |
| 8 | C | 1.15 | 0.85 | 720 | 2.3 | −9.4 | −15.2 | 848 | 242 | 250 |
| 9 | C | 1.15 | 0.85 | 725 | −17.8 | −11.3 | −16.1 | 852 | 241 | 250 |

| | Soaking zone (RTF) | | | | Cooling | | | | | |
|---|---|---|---|---|---|---|---|---|---|---|
| | | Mixed gas | | | zone | Alloying | | | | |
| | | moisture | | | Gas flow | treatment | | Length of | | |
| | Mixed gas | content | | | rate | Alloying | | alloying | Tensile | |
| | dew point | Wr | Gas control in | | Qcd | temperature | Coating | unevenness | strength | |
| No. | (° C.) | (ppm) | furnace upper part | Refiner | (Nm³/hr) | (° C.) | appearance | (m) | (MPa) | Category |
| 1 | — | — | Not performed | Not used | 410 | 556 | Poor | 332 | 575 | Comparative |
| | | | | | | | | | | Example |
| 2 | 2.0 | 6965 | Not performed | Not used | 420 | 501 | Poor | 2 | 622 | Comparative |
| | | | | | | | | | | Example |
| 3 | 2.0 | 6965 | Performed | Used | 413 | 500 | Good | 2 | 621 | Example |
| 4 | — | — | Not performed | Not used | 453 | 575 | Poor | 537 | 752 | Comparative |
| | | | | | | | | | | Example |
| 5 | 5.0 | 8610 | Not performed | Not used | 453 | 512 | Poor | 25 | 811 | Comparative |
| | | | | | | | | | | Example |
| 6 | 5.0 | 8610 | Performed | Used | 453 | 513 | Good | 2 | 805 | Example |
| 7 | — | — | Not performed | Not used | 302 | 602 | Poor | 481 | 957 | Comparative |
| | | | | | | | | | | Example |
| 8 | 5.0 | 8610 | Not performed | Not used | 305 | 511 | Poor | 20 | 1010 | Comparative |
| | | | | | | | | | | Example |
| 9 | 5.0 | 8610 | Performed | Used | 305 | 509 | Good | 1 | 1017 | Example |

### INDUSTRIAL APPLICABILITY

With the disclosed method of producing a galvannealed steel sheet, it is possible to obtain favorable coating appearance with high coating adhesion even in the case of galvannealing a steel strip whose Si content is 0.2 mass % or more, and prevent a decrease in tensile strength by lowering the alloying temperature.

### REFERENCE SIGNS LIST

100 continuous hot-dip galvanizing device
10 heating zone
10A first heating zone (upstream)
10B second heating zone (downstream, direct fired furnace)
12 soaking zone
14 first cooling zone (rapid cooling zone)
16 second cooling zone (slow cooling zone)
18 snout
20 annealing furnace
22 hot-dip galvanizing bath
23 alloying line
24 gas distribution device
26 humidifying device
28 circulating constant-temperature water bath
30 gas mixing device
32 mixed gas dew point meter
34 mixed gas pipe
36A, 36B, 36C mixed gas supply port (timely supply)
38A, 38B, 38C mixed gas supply port (timely supply)
39A, 39B, 39C, 39D dry gas supply port (constant supply)
40A, 40B, 40C dry gas supply port (timely supply)
42A, 42B gas discharge port (timely discharge)
44 refiner
46A, 46B, 46C dew point measurement position
48A upper hearth roll
48B lower hearth roll
P steel strip

1. A method of producing a galvannealed steel sheet using a continuous hot-dip galvanizing device that includes: an annealing furnace in which a heating zone including a direct fired furnace, a soaking zone, and a cooling zone are arranged in the stated order; a hot-dip galvanizing line adjacent to the cooling zone; and an alloying line adjacent to the hot-dip galvanizing line, the method comprising:
annealing a steel strip by conveying the steel strip through the heating zone, the soaking zone, and the cooling zone in the stated order in the annealing furnace;
applying a hot-dip galvanized coating onto the steel strip discharged from the cooling zone, using the hot-dip galvanizing line; and
heat-alloying the galvanized coating applied on the steel strip, using the alloying line,
wherein reducing gas or non-oxidizing gas is supplied into the soaking zone, the reducing gas or the non-oxidizing gas including: mixed gas obtained by mixing gas humidified by a humidifying device and gas not humidified by the humidifying device at a predetermined mixture ratio; and dry gas not humidified by the humidifying device,
the mixed gas is timely supplied into the soaking zone from at least one mixed gas supply port located in a region of lower ½ of the soaking zone in a height direction, and
the dry gas is timely supplied into the soaking zone from at least one dry gas supply port located at or in a range of 2 m lower than a center of an upper hearth roll in the soaking zone in the height direction, and furnace gas is timely discharged from the soaking zone through at least one gas discharge port located higher than the upper hearth roll, to control a dew point in at least an uppermost part of the soaking zone to −20° C. or more and 0° C. or less.

2. The method of producing a galvannealed steel sheet according to claim 1,
wherein the furnace gas discharged through the at least one gas discharge port is introduced into a refiner having a deoxidizing device and a dehumidifying device to remove oxygen and moisture in the furnace gas and decrease a dew point of the furnace gas to obtain second dry gas, and the second dry gas is used as the dry gas timely supplied into the soaking zone from the at least one dry gas supply port.

3. The method of producing a galvannealed steel sheet according to claim 1,
wherein the supply of the mixed gas is controlled so that both a dew point in a region of upper ½ of the soaking zone in the height direction and a dew point in a lowermost part of the soaking zone are −20° C. or more and 0° C. or less.

4. The method of producing a galvannealed steel sheet according to claim 1,
wherein the at least one gas discharge port includes a plurality of gas discharge ports located at a same height position, and/or the at least one dry gas supply port includes a plurality of dry gas supply ports located at a same height position.

5. The method of producing a galvannealed steel sheet according to claim 1,
wherein the at least one mixed gas supply port includes a plurality of mixed gas supply ports located at each of two or more different height positions.

6. The method of producing a galvannealed steel sheet according to claim 1,
wherein an oxidizing burner and a reducing burner situated downstream of the oxidizing burner in a steel sheet traveling direction are provided in the direct fired furnace, and
an air ratio of the oxidizing burner is adjusted to 0.95 or more and 1.5 or less, and an air ratio of the reducing burner is adjusted to 0.5 or more and less than 0.95.

7. The method of producing a galvannealed steel sheet according to claim 2,
wherein the supply of the mixed gas is controlled so that both a dew point in a region of upper ½ of the soaking zone in the height direction and a dew point in a lowermost part of the soaking zone are −20° C. or more and 0° C. or less.

8. The method of producing a galvannealed steel sheet according to claim 2,
wherein the at least one gas discharge port includes a plurality of gas discharge ports located at a same height position, and/or the at least one dry gas supply port includes a plurality of dry gas supply ports located at a same height position.

9. The method of producing a galvannealed steel sheet according to claim 3,
wherein the at least one gas discharge port includes a plurality of gas discharge ports located at a same height position, and/or the at least one dry gas supply port includes a plurality of dry gas supply ports located at a same height position.

10. The method of producing a galvannealed steel sheet according to claim 2,
wherein the at least one mixed gas supply port includes a plurality of mixed gas supply ports located at each of two or more different height positions.

11. The method of producing a galvannealed steel sheet according to claim 3,
wherein the at least one mixed gas supply port includes a plurality of mixed gas supply ports located at each of two or more different height positions.

12. The method of producing a galvannealed steel sheet according to claim 2,
wherein an oxidizing burner and a reducing burner situated downstream of the oxidizing burner in a steel sheet traveling direction are provided in the direct fired furnace, and
an air ratio of the oxidizing burner is adjusted to 0.95 or more and 1.5 or less, and an air ratio of the reducing burner is adjusted to 0.5 or more and less than 0.95.

13. The method of producing a galvannealed steel sheet according to claim 3,
wherein an oxidizing burner and a reducing burner situated downstream of the oxidizing burner in a steel sheet traveling direction are provided in the direct fired furnace, and
an air ratio of the oxidizing burner is adjusted to 0.95 or more and 1.5 or less, and an air ratio of the reducing burner is adjusted to 0.5 or more and less than 0.95.
